(19) United States
(12) Patent Application Publication
(10) Pub. No.: US 2022/0166077 A1
(43) Pub. Date: May 26, 2022

(54) ENERGY STORAGE DEVICE FOR STORING ELECTRICAL ENERGY, METHOD OF OPERATING AN ENERGY STORAGE DEVICE, AND MOTOR VEHICLE

(71) Applicant: AUDI AG, Ingolstadt (DE)

(72) Inventors: Tamas GYULAI, Pfaffenhofen an der Ilm (DE); Eduard MAIN, Buxheim (DE); Walter SCHMIEDER, Hepberg (DE)

(73) Assignee: AUDI AG, Ingolstadt (DE)

(21) Appl. No.: 17/513,160

(22) Filed: Oct. 28, 2021

(30) Foreign Application Priority Data
Nov. 23, 2020 (DE) 102020130834.5

(51) Int. Cl. H01M 10/48

(52) U.S. Cl. CPC H01M 10/48; H01M 2220/20

(57) ABSTRACT

An energy storage device for storing electrical energy. The energy storage device has an energy storage housing for receiving at least one battery cell stack and a control device. The at least one battery cell stack has at least two battery cells and is arranged between at least two opposite housing walls of the energy storage housing. The energy storage device has at least one sensor device which is arranged between the at least one battery cell stack and one of the housing walls of the energy storage housing, and which is configured to detect a mechanical pressure exerted by the battery cell stack and the housing wall on one another, and provide this as measurement data to the control device.

### FIELD

The invention relates to an energy storage device for storing electrical energy, a method for operating an energy storage device, and a motor vehicle comprising at least one energy storage device.

### BACKGROUND

Energy storage devices for storing energy in electrically operated motor vehicles presently comprise lithium-ion cells. Due to aging processes in lithium-ion cells in electrical energy storage devices, there is a loss of capacity and a higher probability of failure of the energy storage device with age and the number of charging cycles.

The state of aging influenced by these aging processes is presently determined using three indicators. The first indicator, which enables conclusions to be drawn about the state of aging of the energy storage device, is the voltage spread between individual battery cells of a battery cell stack of the energy storage device. This voltage spread increases as the lithium ion cells age. According to the present prior art, however, no predictions regarding the exact state of aging and the expected further service life of the energy storage device can be derived from the voltage spread.

Another indicator of the state of aging of a stack is the temperature distribution within the battery cell stack. The aging of the battery cells results in an inhomogeneous temperature distribution within the battery cell stack during operation. However, this inhomogeneity in the temperature distribution develops very slowly and is usually detected in a state of very advanced aging when a pronounced loss of capacity and a pronounced voltage spread have already been determined. Monitoring the inhomogeneity of the temperature distribution is not a suitable indicator for a timely determination of a state of aging.

A further indicator of aging is the pressure occurring in the battery cell. As the battery cell ages, the volume of the battery cell increases. This is due to the fact that gas is generated during the aging processes of lithium-ion cells. With increasing aging, the gas increases and the volume of the cell grows. Since the cell is pre-tensioned by a housing and thus the increase in volume is restricted, this process results in an increase in pressure in the cell, which loads the battery housing and possibly deforms it.

The increase in pressure depends on the aging of the battery cells and is measurable over the entire service life of the battery cell. The pressure is therefore a suitable indicator to determine the aging status during the entire service life of the cell.

The relationship between the pressure in the battery cell and the state of aging of the cell is determined by testing or simulation, which studies the extent to which the pressure in the battery cell increases due to the aging process.

A determination of the pressure curve to be expected is particularly necessary for the design of the housing of the energy storage device. The materials and geometries of the housing are to be selected according to the occurring pressure conditions.

Pressure sensors are used to detect the pressure. Typical energy storage devices have a hierarchy made up of battery cells, battery cell stacks, and battery cell modules. Here the pressure sensors are arranged between the battery cell modules and the housing of the energy storage device. However, newer energy storage devices are structured according to the so-called cell-to-pack hierarchy. In this case, the level of the battery cell modules is dispensed with. Instead, the battery cell stacks are installed directly in the battery cell housing. The battery cell stacks are in direct contact with the outer housing of the energy storage device. No solution for the arrangement of the pressure sensors has yet been developed for this hierarchy

DE 10 2017 220 644 A1 describes a possible arrangement of pressure sensors in an energy storage module having the known hierarchy. This discloses an energy storage module and a method for operating an energy storage module. The energy storage module comprises at least one battery cell which is arranged between two end plates of a module housing. The energy storage module comprises a sensor device which has at least one pressure sensor which is arranged between the battery cell and one of the end plates.

DE 10 2013 015 700 A1 describes a method for producing a battery cell and a battery cell. It is provided here that at least one sensor is attached at a point within a housing of the battery cell at which, in dependence on the structural shape, a variable detectable by means of at least one sensor has a higher value during operation of the battery cell than at other points within the housing. This at least one sensor can be a pressure sensor, for example.

DE 10 2020 002 514 A1 discloses a battery system having at least one battery cell. The battery system comprises a pressure sensor and is configured to determine a measured value with regard to a deformation of the battery cell and to use this measured value to generate a warning and/or shutdown message. In this case, a spring element is arranged in such a way that the measured values are compensated for more strongly in the case of smaller deformations than in the case of larger deformations.

DE 10 2017 219 687 A1 discloses a housing part for a housing of a traction battery of an electrically drivable motor vehicle. The housing part has at least one wall made of plastic, wherein at least one, in particular closed chamber for receiving one or more insert parts is formed in the wall. It is described that, for example, at least one pressure sensor is inserted in the chamber.

An implementation of the pressure measurement for cell-to-pack battery concepts is presently not known.

### SUMMARY

It is therefore an object of the invention to provide a solution which enables a state of aging to be detected in energy storage devices according to the cell-to-pack battery concept.

The invention comprises an energy storage device for storing electrical energy. The energy storage device has an energy storage housing for receiving at least one battery cell stack and a control device. The energy storage device can be, for example, a traction battery of a motor vehicle, which is designed, for example, as a lithium-ion accumulator. The energy storage device can be constructed according to the so-called cell-to-pack concept. This means that instead of the typical hierarchy consisting of multiple battery cells which are arranged in a battery cell module, which in turn are arranged in the battery housing, there is an arrangement of the battery cells in at least one battery cell stack which is enclosed by the energy storage housing together with the control device. The energy storage housing can be provided to protect the battery cells from mechanical stress, for example due to an accident. The at least one battery cell stack has at least two battery cells, wherein these can be lithium-ion battery cells. This at least one battery cell stack is arranged between at least two opposite housing walls of the energy storage housing. It is provided that the energy storage device has at least one sensor device which is arranged between the at least one battery cell stack and one of the housing walls of the energy storage housing. In other words, the sensor device is located in an area between one of the housing walls and the battery cell stack. The sensor device is configured to detect a mechanical pressure exerted on one another by the battery cell stack and the housing wall and to provide it to the control device as measurement data. In other words, the sensor device is provided to detect the pressure between the housing wall and the battery cell stack. The detected values of the pressure are provided by the sensor device to the control device. For this purpose, the sensor device can be connected to the control device using a cable. The sensor device can, for example, be configured to detect a present pressure between the battery cell stack and the housing wall upon receiving a request signal from the control device and to provide this as measurement data to the control device. It can also be provided that the sensor device is configured to continuously detect the pressure, for example at a predetermined interval, and to provide the measurement data to the control device so that these data can be logged in a series of measurements in the control device. Alternatively thereto, it can also be provided that the sensor device continuously detects the pressure, but only transmits the measurement data to the control device as measurement data when the values exceed or fall below predetermined threshold values.

The invention also comprises refinements which result in further advantages

One refinement of the invention provides that the at least one sensor device has at least two pressure sensors which differ from one another in their measuring range. In other words, it is provided that at least two pressure sensors are used, wherein the pressure sensors are configured to detect respective different pressure ranges. The advantage thus results that the sensor device can be optimized for the detection of different value ranges. It can be the case, for example, that the pressure increases at different rates of increase in the course of the aging process of the battery cell stack. This can make it necessary for a pressure sensor for detecting a value range having a lower rate of increase to have a higher measurement accuracy than a pressure sensor for detecting a value range having a higher rate of increase. The latter can be designed for higher pressure values or a larger value range. It can be provided that the sensor device detects the pressure by means of a first pressure sensor and, after the pressure exceeds a predetermined threshold value, detects it by means of a second pressure sensor which is designed for higher values of the pressure.

One refinement of the invention provides that at least one of the pressure sensors is designed as an expansion band. In other words, it is provided that the pressure between the housing wall and the battery cell stack is detected by the change of a length of an expansion band which is arranged, for example, on the housing wall or a wall of the battery cell stack. The advantage thus results that the pressure can be determined via a change of the bend of the housing wall or the wall of the battery cell stack. It can be provided that the housing wall has a curvature in order to exert pressure on the battery cell stack as a leaf spring. With increasing pressure of the battery cell stack on the housing wall, its curvature can decrease. This change of the curvature can be determined by detecting a change in length of an expansion band arranged on the housing wall.

One refinement of the invention provides that at least one of the pressure sensors is a piezoelectric pressure sensor. In other words, the pressure is detected in at least one of the sensor units by means of the piezoelectric effect. The advantage thus results that a relatively robust pressure sensor is used.

One refinement provides that the energy storage device has at least two sensor devices, wherein the at least two sensor devices are arranged at opposite ends of the battery cell stack. In other words, it is provided that the battery cell stack arranged between two walls is connected to a wall at two opposite ends via a respective sensor device. If the battery cell stack expands due to the aging process, the pressure is exerted on the two sensor devices to the same extent by the battery cell stack. It is thus possible to carry out a redundant measurement and therefore ensure that the values are reliable.

One refinement of the invention provides that the control device is configured to store the measurement data and/or to provide them via an interface. In other words, it is provided that the measurement data are permanently stored by the control device. As a result, the control device can, for example, create a series of measurements of the measurement data, as a result of which the course of the pressure can be logged. The control device can also comprise an interface, which makes it possible to provide the measurement data received and/or stored by the sensor device to an external device. The advantage thus results that it is not necessary to open the energy storage device in order to determine the internal pressure.

One refinement of the invention provides that an aging profile is stored in the control device and the control device is configured to determine a state of aging of the battery cell stack from the measurement data by means of the aging profile. In other words, a factor, a table, or a curve is stored in the control device which describes an expected course of the measurement data as a function of the state of aging of the battery cells. This makes it possible for the control device to determine the state of aging in which the battery cells are. The advantage thus results that the state of aging can be estimated by the control device. It can be provided, for example, that the determined state of aging of the battery cell stack is transmitted from the control device to a network of a motor vehicle via an interface.

One refinement of the invention provides that the control device is configured to identify a functional error of the battery cell stack by means of the aging profile from the measurement data. In other words, the control device is configured to identify whether there is a functional error in the battery cell stack by evaluating the measurement data by means of the aging profile.

The advantage thus results that a functional error can be detected early by the energy storage device. For example, a permissible value range for the detected pressure values can be specified by the aging profile. The control device can check whether the detected pressure values are within the permissible value ranges. If this is not the case, the control device can determine the presence of the functional error and, for example, output a warning signal.

The invention also comprises a method for operating an energy storage device for storing electrical energy as claimed in any one of the preceding claims. The method provides that the energy storage device has an energy storage housing for receiving at least one battery cell stack and a control device, and the at least one battery cell stack has at least two battery cells and is arranged between at least two opposite housing walls of the energy storage housing. The energy storage device has at least one sensor device, which is arranged between the at least one battery cell stack and one of the housing walls of the energy storage housing, and by which a mechanical pressure exerted by the battery cell stack and the housing wall on one another is detected and provided as measurement data to the control device.

The invention also comprises a motor vehicle having an energy storage device for storing electrical energy.

The motor vehicle according to the invention is preferably designed as an automobile, in particular as a passenger car or truck, or as a passenger bus or motorcycle.

The invention also includes refinements of the method according to the invention and the motor vehicle according to the invention, which have features as already described in the context of the refinements of the energy storage device according to the invention. For this reason, the corresponding refinements of the method according to the invention and the motor vehicle according to the invention are not described again here.

The invention also includes the control device for the energy storage device. The control device can have a data processing device or a processor device which is configured to carry out an embodiment of the method according to the invention. For this purpose, the processor device can have at least one microprocessor and/or at least one microcontroller and/or at least one FPGA (Field Programmable Gate Array) and/or at least one DSP (Digital Signal Processor).

Furthermore, the processor device can have program code which is configured to carry out the embodiment of the method according to the invention when it is executed by the processor device. The program code can be stored in a data memory of the processor device.

The invention also comprises combinations of the features of the described embodiments. The invention therefore also includes implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a possible structure of a motor vehicle, comprising an energy storage device for storing electrical energy;

FIG. 2 shows a possible course of a pressure.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those shown. Furthermore, the described embodiments can also be supplemented by further features of the invention that have already been described.

In the figures, the same reference signs designate elements that have the same function.

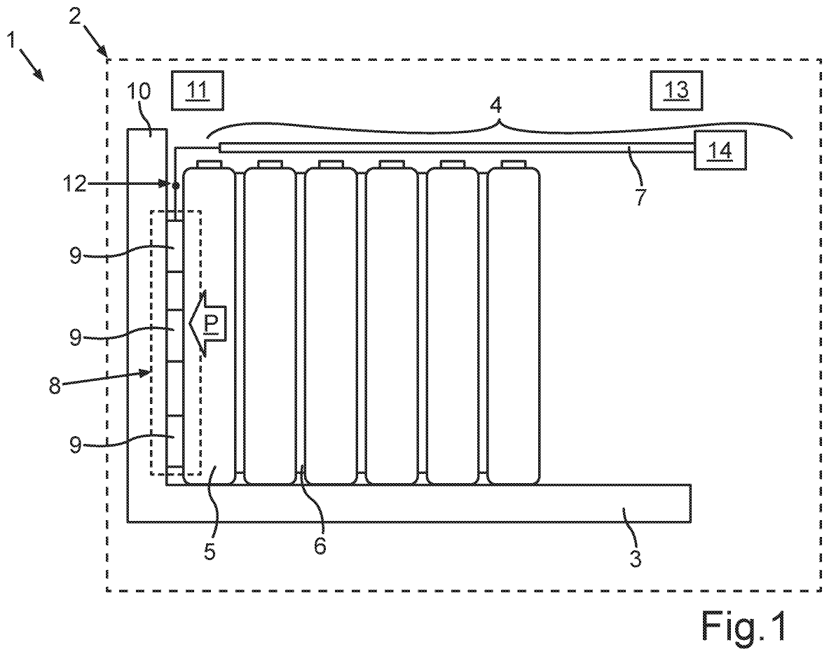

FIG. 1 shows a possible structure of a motor vehicle 1, comprising an energy storage device 2 for storing electrical energy. It can be provided that the energy storage device 2 for storing the electrical energy required for the drive can be installed in the motor vehicle 1, which can be designed as a fully electrically operated vehicle or as a hybrid motor vehicle. The energy storage device 2 can thus be a traction battery of the motor vehicle 1. In order to protect the active functional components of the energy storage device 2 from environmental influences or mechanical deformations, the energy storage device 2 can have an energy storage housing 3.

This energy storage housing 3, also referred to as a battery frame, can comprise steel. In this energy storage housing 3, at least one battery cell stack 4 can be arranged, which can comprise multiple prismatic battery cells 5, between which partition walls 6 can be arranged. The energy storage device 2 can be constructed according to the so-called cell-to-pack principle. The energy storage device 2 can also have a control device 7, which can likewise be enclosed by the energy storage housing 3. The battery cells 5 can be lithium-ion cells. These have the property that they deform with increasing age and increase in volume. Due to the increase in the volume of the individual battery cells 5, a pressure P is exerted on a housing wall 10 of the energy storage housing 3 by the battery cell stack 4. The more the aging has progressed, the greater the pressure P which is exerted on the energy storage housing 3 by the battery cell stack 4. There is thus a connection between the pressure P exerted by the battery cell stack 4 on the energy storage housing 3 and the state of aging of the battery cells 5 of the battery cell stack 4.

In order to be able to detect the pressure course, a sensor device 8 can be arranged between at least one housing wall 10 of the energy storage housing 3 and the battery cell stack 4. The sensor device 8 can have one or more pressure sensors 9, which can detect the pressure between the housing wall 10 and the battery cell stack 4. The pressure sensors 9 can be designed as piezoelectric pressure sensors, for example. It can also be possible for the pressure sensors 9 to be designed as expansion bands which are arranged on the housing wall 10. The pressure sensors 9 can abut an outer battery cell 5 of the battery cell stack 4. It can be provided that one of the pressure sensors 9 is arranged in the middle of a surface opposite to the housing wall 10, because a maximum pressure can be transmitted there by the battery cell stack 4 to the housing wall 10. It can also be provided that the pressure sensors 9 are arranged at different points on the outer surface of the battery cell stack 4. The pressure sensors 9 can differ from one another in their measuring range. It can be provided, for example, that a respective pressure sensor 9 is provided for a predetermined pressure range. The pressure sensors 9 can detect the pressure and send it as measurement data 11 to the control device 7, for example via a cable 12. The control device 7 can receive the measurement data 11 and store them in a memory of the control device 7. The pressure P can be detected several times over a period of time, for example, or on request by the control device 7. If the pressure P is detected regularly, the measurement data 11 received by the control device 7 can be stored in a series of measurements. A profile 13 can be stored in the control device 7 which sets the pressure in conjunction with the state of aging of the battery cells 5 of the battery cell stack 4. This can be a curve course, for example. The control device 7 can be configured to determine a state of aging of the battery cells 5 from the measurement data 11 by means of the stored profile 13. The control device 7 can have an interface 14 at which, for example, the measurement data 11 or the determined state of the battery cells 5 is provided. The interface 14 can be read out, for example, in a workshop or connected to a network, for example an Ethernet network or a CAN bus network of the motor vehicle 1.

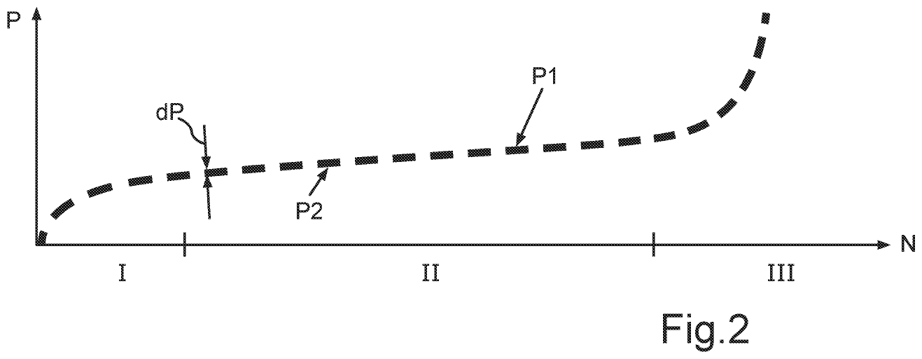

FIG. 2 shows a possible course of a pressure P between a housing wall 10 and a battery cell stack 4 over a number of charging cycles N of the energy storage device 2. The range shown shows an upper course P1 and a lower course P2. Range The upper course P1 shows the maximum value of the pressure P during a charging cycle, the lower course P2 shows a minimum value of the pressure P during a charging cycle. The width dP between the curves P1, P2 shows a change in the pressure P during a charging cycle. It can be seen that in an initial range I of the number of charging cycles there is a sharp increase in the curves, which increases only slightly in a central range II of the number of charging cycles. In an end range III of the number of charging cycles, a sharper increase of the curves takes place. This means that, in particular at the beginning I and towards the end III of the service life of the energy storage device 2, there is a stronger increase in the pressure P in a battery cell 5 as a function of the number of charging cycles N than in the middle phase of life II. It can be provided that a respective pressure sensor 9 is provided for the different pressure ranges I, II, III. The respective pressure sensor 9 can be designed for the pressure ranges of different levels of the respective phase I, II, III. The course of the curves P1, P2 can be stored as a profile 13 in the control device 7. By comparing the stored measurement data 11 to the profile 13, the control device 7 can determine the cell aging.

The invention describes how a pressure sensor can be used in a cell-to-pack concept.

There is presently no pressure sensor in a cell-to-pack concept that specifically measures the pressure increase in the first cell in the battery cell stack (a series of interconnected cells in the battery housing).

Gas is created in the cell due to the use of lithium ions in the cell module. Over time, this gas becomes more and more and a pressure arises in the cell, which loads the battery housing and possibly deforms it. This growth and the pressure development—i.e., aging—depend on how heavily the cell is loaded (c-rate*, driving profile, and also the interconnection of the cell module).

There are three indicators that can describe the state of aging of a battery cell stack:
1. Voltage spread between the battery cells
2. High level of inhomogeneity of the temperature distribution in the battery cell stack
3. Pressure (or force) in the battery cell stack or in the cell

The voltage spread between the battery cells is monitored, but it is presently not possible to make a prediction with respect to the state of aging from the sequence of the voltage curves.

An inhomogeneity in the temperature distribution occurs very slowly and if the inhomogeneity is determined, it is usually too late, a rapid loss of capacity and a voltage spread are also determined.

The pressure in the cell thus remains as an indicator, which can be used to determine the state of aging of the battery cell stack.

During the development of the cell, it is ascertained by testing how the cell behaves, i.e., how high the pressure in the cell will become that results in the case of a specific driving profile or test profile.

These measured values are determined during development. This pressure—or this force—is primarily used to determine the housing construction, for example when selecting materials or determining the geometry of walls, and as information feedback in battery cell development.

There is currently no pressure sensor in the cell-to-pack constructions, so the pressure increase in the cell is not monitored over the service life. The battery cell stack is usually in direct contact with the housing.

The invention describes how the pressure built up by the cell during operation can be measured in the battery. Piezoelectric pressure sensors are installed between the battery housing and the first cell. The pressure sensor measures the pressure that results due to the cyclization of the cell. This signal is passed on to the battery cell stack controller via a cable, where it is processed and stored.

These measured values are stored over the service life of the battery, and the measurement data can thus be read out without opening the battery. The measured values can be compared to the curve from the development and thus the aging of the battery can be determined. The pressure sensors are installed on both sides of the battery cell stack to ensure redundancy.

A pressure sensor is installed in the middle of the cell, this pressure sensor has a large area, because the growth of the cell is greatest in the middle. It is advisable to install additional and smaller pressure sensors in order to know the growth on the entire surface of the cell.

Another possibility, instead of installing the pressure sensor between the battery housing and a cell, is to arrange it on or in a spring plate, by which the battery cell stack is pre-tensioned.

If the pressure is continuously registered—and compared to the curve that was determined during development—it can be determined in advance whether a rapid loss of capacity will occur (for example due to a malfunction of the cell).

If a possible loss of capacity is detected, an appointment for a repair or replacement of the battery cell stack could be made automatically with the workshop.

The developer could obtain information about how a cell-to-pack battery is used in everyday life and deduce from this whether the construction is designed to be sufficiently robust, or whether material can possibly be saved because the battery and the vehicle are used differently in real operation than was assumed during the development.

Furthermore, not only the battery developer can profit from this information, but also the field of simulation, which determines the driving profiles for the design of the cell.

Overall, the examples show how pressure detection can be provided in an energy storage device according to the cell-to-pack concept.

1. An energy storage device for storing electrical energy, comprising:
an energy storage housing for receiving at least one battery cell stack and a control device, and
the at least one battery cell stack has at least two battery cells and is arranged between at least two opposite housing walls of the energy storage housing, wherein
the energy storage device has at least one sensor device which is arranged between the at least one battery cell stack and one of the housing walls of the energy storage housing, and which is configured to detect a pressure exerted by the battery cell stack and the housing wall on one another, and provide this as measurement data to the control device.

2. The energy storage device as claimed in claim 1, wherein the at least one sensor device has at least two pressure sensors which differ from one another in their measuring range of the pressure.

3. The energy storage device as claimed in claim 1, wherein the at least one sensor device has at least one pressure sensor which is designed as an expansion band.

4. The energy storage device as claimed in claim 1, wherein the at least one sensor device has at least one pressure sensor which is designed as a piezoelectric pressure sensor.

5. The energy storage device as claimed in claim 1, wherein the energy storage device has at least two sensor devices, wherein the at least two sensor devices are arranged at opposite ends of the battery cell stack.

6. The energy storage device as claimed in claim 1, wherein the control device is configured to store the measurement data and/or to provide them via an interface.

7. The energy storage device as claimed in claim 1, wherein an aging profile is stored in the control device, and the control device is configured to determine a state of aging of the battery cell stack from the aging profile together with the measurement data.

8. The energy storage device as claimed in claim 7, wherein the control device is configured to identify a functional error of the battery cell stack from the aging profile with the measurement data.

9. A method for operating an energy storage device, comprising
an energy storage housing receiving at least one battery cell stack and a control device, and
the at least one battery cell stack has at least two battery cells and is arranged between at least two opposite housing walls of the energy storage housing, wherein
the energy storage device has at least one sensor device which is arranged between the at least one battery cell stack and one of the housing walls of the energy storage housing, and
a pressure exerted by the battery cell stack and the housing wall on one another is detected by the sensor device, and the detected pressure is provided as measurement data to the control device.

10. A motor vehicle comprising at least one energy storage device as claimed in claim 1.

11. The energy storage device as claimed in claim 2, wherein the at least one sensor device has at least one pressure sensor which is designed as an expansion band.

12. The energy storage device as claimed in claim 2, wherein the at least one sensor device has at least one pressure sensor which is designed as a piezoelectric pressure sensor.

13. The energy storage device as claimed in claim 2, wherein the energy storage device has at least two sensor devices, wherein the at least two sensor devices are arranged at opposite ends of the battery cell stack.

14. The energy storage device as claimed in claim 3, wherein the energy storage device has at least two sensor devices, wherein the at least two sensor devices are arranged at opposite ends of the battery cell stack.

15. The energy storage device as claimed in claim 4, wherein the energy storage device has at least two sensor devices, wherein the at least two sensor devices are arranged at opposite ends of the battery cell stack.

16. The energy storage device as claimed in claim 2, wherein the control device is configured to store the measurement data and/or to provide them via an interface.

17. The energy storage device as claimed in claim 3, wherein the control device is configured to store the measurement data and/or to provide them via an interface.

18. The energy storage device as claimed in claim 4, wherein the control device is configured to store the measurement data and/or to provide them via an interface.

19. The energy storage device as claimed in claim 5, wherein the control device is configured to store the measurement data and/or to provide them via an interface.

20. The energy storage device as claimed in claim 2, wherein an aging profile is stored in the control device, and the control device is configured to determine a state of aging of the battery cell stack from the aging profile together with the measurement data.
